(19) United States
(12) Patent Application Publication
(10) Pub. No.: US 2007/0067719 A1
(43) Pub. Date: Mar. 22, 2007

(54) Identifying possible restricted content in electronic communications

(75) Inventors: Edward K.Y. Jung, Bellevue, WA (US); Royce A. Levien, Lexington, MA (US); Robert W. Lord, Seattle, WA (US); Mark A. Malamud, Seattle, WA (US); John D. Rinaldo JR., Bellevue, WA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC, a limited liability corporation of the State of Delaware

(21) Appl. No.: 11/233,478

(22) Filed: Sep. 21, 2005

Related U.S. Application Data
(63) Continuation-in-part of application No. 11/233,402, filed on Sep. 21, 2005.

(51) Int. Cl. G06F 17/00

(52) U.S. Cl. 715/531

(57) ABSTRACT

In one aspect, a method related to electronic communications. In addition to the foregoing, other method and system and program product aspects are described in the claims, drawings, and text forming a part of the present application.

### CROSS-REFERENCE TO RELATED APPLICATIONS

The present application is related to, claims the earliest available effective filing date(s) from (e.g., claims earliest available priority dates for other than provisional patent applications; claims benefits under 35 USC §119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith. The United States Patent Office (USPTO) has published a notice to the effect that the USPTO's computer programs require that patent applicants reference both a serial number and indicate whether an application is a continuation or continuation in part. Stephen G. Kunin, Benefit of Prior-Filed Application, USPTO Electronic Official Gazette, Mar. 18, 2003 at http://www.uspto.gov/web/offices/com/sol/og/2003/week11/patbene.htm. The present applicant entity has provided below a specific reference to the application(s)from which priority is being claimed as recited by statute. Applicant entity understands that the statute is unambiguous in its specific reference language and does not require either a serial number or any characterization such as “continuation” or “continuation-in-part.” Notwithstanding the foregoing, applicant entity understands that the USPTO's computer programs have certain data entry requirements, and hence applicant entity is designating the present application as a continuation in part of its parent applications, but expressly points out that such designations are not to be construed in any way as any type of commentary and/or admission as to whether or not the present application contains any new matter in addition to the matter of its parent application(s).

### Related Applications

1. For purposes of the USPTO extra-statutory requirements, the present application constitutes a continuation in part of currently co-pending United States patent application entitled Reviewing Electronic Communications for Possible Restricted Content, naming Edward K. Y. Jung; Royce A. Levien; Robert W. Lord; Mark A. Malamud; and John D. Rinaldo, Jr. as inventors, USAN: To be assigned, filed contemporaneously herewith on Sep. 21, 2005.

### TECHNICAL FIELD

The present application relates, in general, to electronic communications.

### SUMMARY

In one aspect, a method of conducting virtual world transactions includes but is not limited to reviewing a draft electronic communications text for possible restricted content; and identifying the possible restricted content. In addition to the foregoing, other method aspects are described in the claims, drawings, and text forming a part of the present application.

In one aspect, a system related to virtual world transactions includes but is not limited to circuitry for reviewing a draft electronic communications text for possible restricted content; and circuitry for identifying the possible restricted content. In addition to the foregoing, other system aspects are described in the claims, drawings, and text forming a part of the present application.

In one or more various aspects, related systems include but are not limited to circuitry and/or programming and/or electro-mechanical devices and/or optical devices for effecting the herein-referenced method aspects; the circuitry and/or programming and/or electro-mechanical devices and/or optical devices can be virtually any combination of hardware, software, and/or firmware configured to effect the herein-referenced method aspects depending upon the design choices of the system designer skilled in the art.

In one aspect, a program product includes but is not limited to a signal bearing medium bearing one or more instructions for reviewing a draft electronic communications text for possible restricted content; and one or more instructions for identifying the possible restricted content. In addition to the foregoing, other program product aspects are described in the claims, drawings, and text forming a part of the present application.

In addition to the foregoing, various other method, system, and/or program product aspects are set forth and described in the teachings such as the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1 depicts one implementation of an exemplary environment in which the methods and systems described herein may be represented;

FIG. 2 depicts a high-level logic flowchart of an operational process;

FIG. 3 shows several alternative implementations of the high-level logic flowchart of FIG. 2;

FIG. 4 shows several alternative implementations of the high-level logic flowchart of FIG. 2; and

FIG. 5 shows several alternative implementations of the high-level logic flowchart of FIG. 2.

The use of the same symbols in different drawings typically indicates similar or identical items.

### DETAILED DESCRIPTION

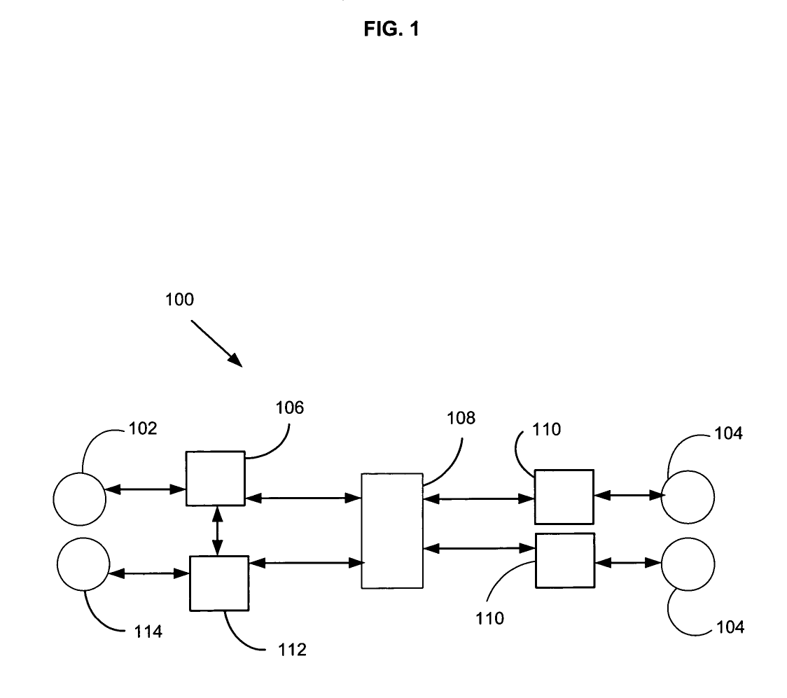

With reference to the figures, FIG. 1 depicts one implementation of an exemplary environment 100 in which the methods and systems described herein may be represented. A person 102 working for a business and/or an entity with a need to communicate with a person or persons who are members of the public or the media, customers, suppliers and/or other persons and/or entities 104 prepare a draft electronic communications text including language text and/or illustrations and/or attachments and/or links to Internet-available resources, using a computer 106. The computer 106 may be a desktop computer or a laptop or another type of computer unit with which electronic communications may be prepared, and is operably coupled to computing resources, here represented by computer unit 108, allowing access to the Internet. The draft electronic communications text is designed to be posted to a weblog or other Internet communications forum, or included in email, that is accessible to the persons 104 via computers 110, which may be desktop computers or laptop or another type of computer unit with which electronic communications may be viewed, and are operably coupled to computing resources, here represented by computer unit 108, allowing access to the Internet. The draft electronic communications text is accepted by software running on computer 106 and/or computer 112, where computer 112 is operably coupled to computer 106, so that it may be reviewed for possible restricted content by a reviewer 114. The reviewer 114 may be one or more human reviewers and/or computing resources.

One skilled in the art will recognize that the herein described components (e.g., steps), devices, and objects and the discussion accompanying them are used as examples for the sake of conceptual clarity and that various configuration modifications are within the skill of those in the art. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

Following is a series of flowcharts depicting implementations of processes. For ease of understanding, the flowcharts are organized such that the initial flowcharts present implementations via an overall “big picture” viewpoint and thereafter the following flowcharts present alternate implementations and/or expansions of the “big picture” flowcharts as either sub-steps or additional steps building on one or more earlier-presented flowcharts. Those having skill in the art will appreciate that the style of presentation utilized herein (e.g., beginning with a presentation of a flowchart(s) presenting an overall view and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

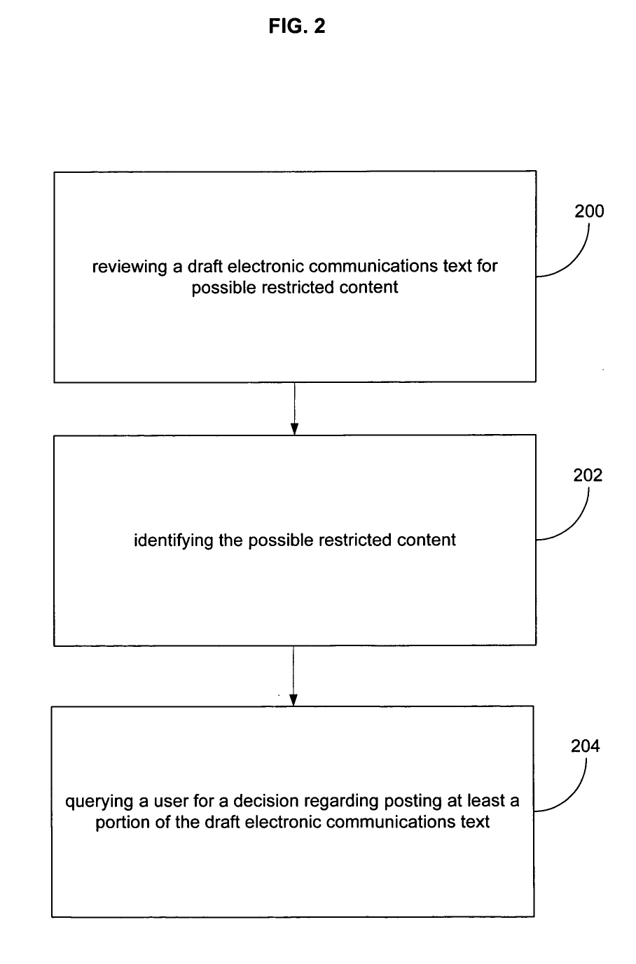

FIG. 2 depicts a high-level logic flowchart of an exemplary operational process. Operation 200 shows reviewing a draft electronic communications text for possible restricted content (e.g., reviewing the draft electronic communications text on computer 106 and/or 112, where the review is performed by reviewer 114). Operation 202 illustrates identifying the possible restricted content (e.g., identifying for the reviewer 114 using computer 106 and/or 112 any words and/or phrases and/or illustrations that is possible restricted content). The exemplary operational process of may also include operation 204, which shows querying a user for a decision regarding posting at least a portion of the draft electronic communications text.

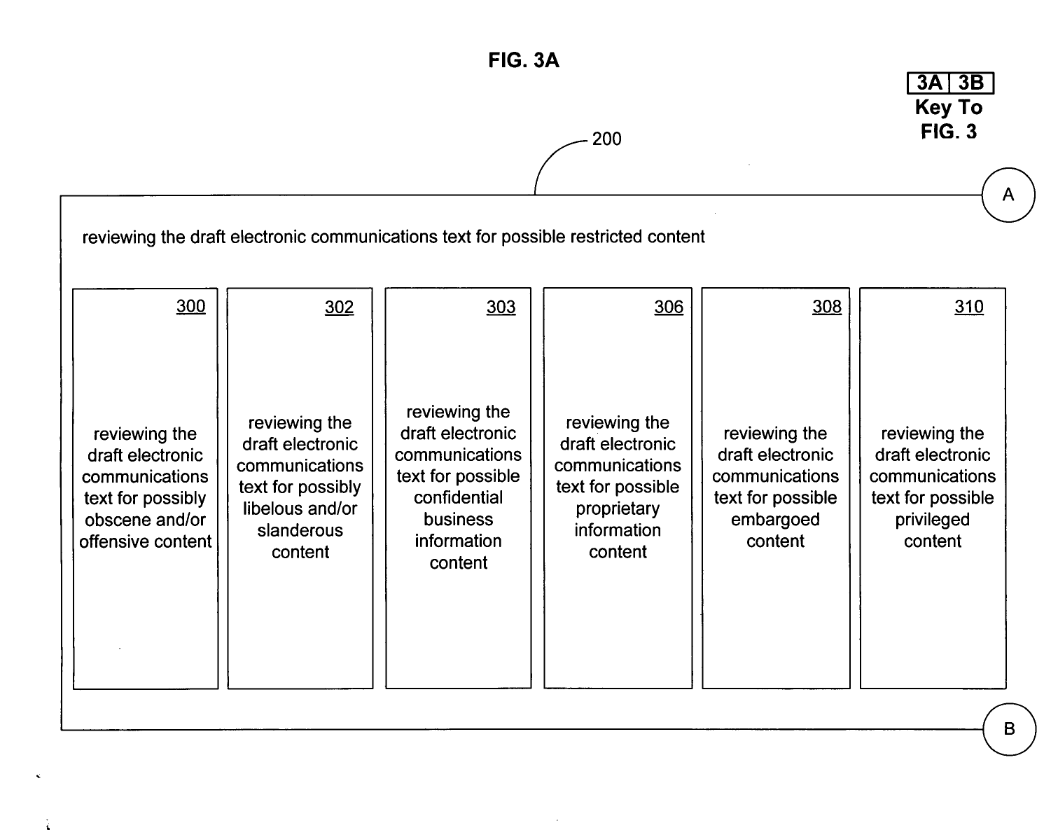

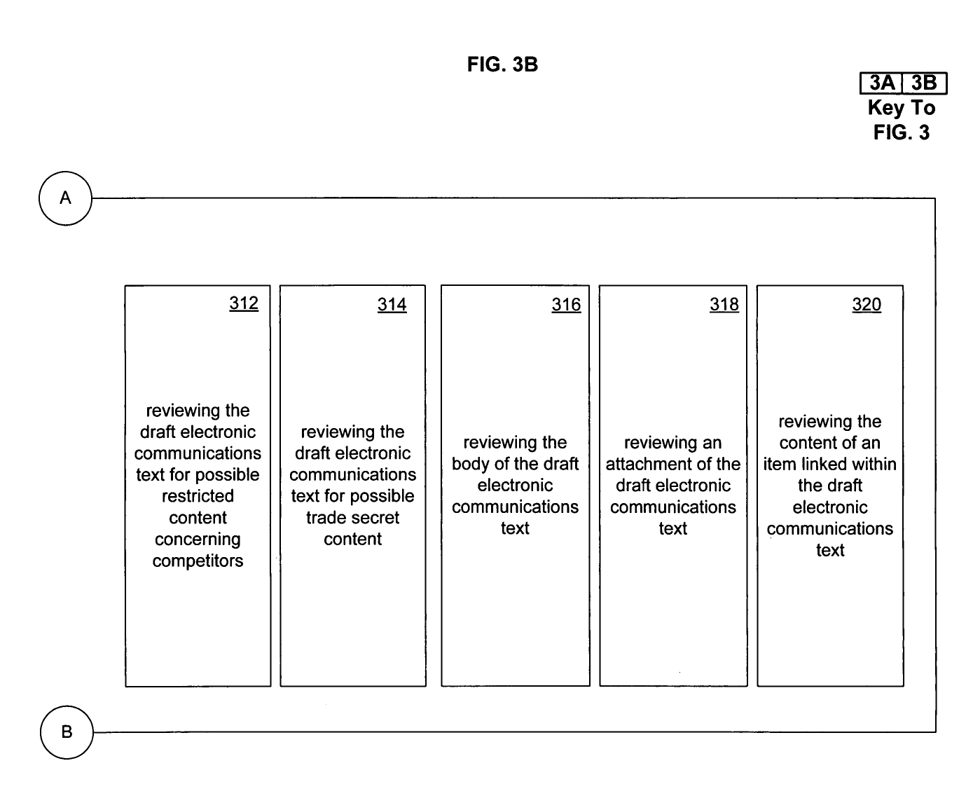

FIG. 3 shows several alternative implementations of the high-level logic flowchart of FIG. 2. Depicted is that operation 200—reviewing a draft electronic communications text for possible restricted content—may include one or more of the following operations: 300, 302, 304, 306, 308, 310, 312, 314, 316, 318, and 320. Operation 300 shows reviewing the draft electronic communications text for possibly obscene and/or offensive content (e.g., reviewing the draft electronic communications text prepared by person 102, where the reviewing is performed on computer 106 and/or 112 by reviewer 114, for words and/or phrases and/or illustrations that might be obscene or offensive, such as swear words or racial epithets). Operation 302 illustrates reviewing the draft electronic communications text for possibly libelous and/or slanderous content (e.g., reviewing the draft electronic communications text prepared by person 102, where the reviewing is performed on computer 106 and/or 112 by reviewer 114, for words and/or phrases and/or illustrations that might place the person 102 and/or the entity for whom she works at risk of a suit for libel or slander). Operation 304 illustrates reviewing the draft electronic communications text for possible confidential business information content (e.g., reviewing the draft electronic communications text prepared by person 102, where the reviewing is performed on computer 106 and/or 112 by reviewer 114, for words and/or phrases and/or illustrations that might publicly reveal information such as confidential customer lists and/or customer data such as names, addresses, and/or phone numbers). Operation 306 shows reviewing the draft electronic communications text for possible proprietary information content (e.g., reviewing the draft electronic communications text prepared by person 102, where the reviewing is performed on computer 106 and/or 112 by reviewer 114, for words and/or phrases and/or illustrations that might reveal information important to a competitive business position such as the technical contents of a bid for work). Operation 308 depicts reviewing the draft electronic communications text for possible embargoed content (e.g., reviewing the draft electronic communications text prepared by person 102, where the reviewing is performed on computer 106 and/or 112 by reviewer 114, for words and/or phrases and/or illustrations that might reveal information that is not to be publicly disclosed until some point in the future, such as the text of a to-be-released book). Operation 310 depicts reviewing the draft electronic communications text for possible privileged content (e.g., reviewing the draft electronic communications text prepared by person 102, where the reviewing is performed on computer 106 and/or 112 by reviewer 114, for words and/or phrases and/or illustrations that might reveal legally privileged information such as communications between attorneys and their clients). Operation 312 shows reviewing the draft electronic communications text for possible restricted content concerning competitors (e.g., reviewing the draft electronic communications text prepared by person 102, where the reviewing is performed on computer 106 and/or 112 by reviewer 114, for words and/or phrases and/or illustrations that might reveal information about competitors, such as comparative product test results). Operation 314 illustrates reviewing the draft electronic communications text for possible trade secret content (e.g., reviewing the draft electronic communications text prepared by person 102, where the reviewing is performed on computer 106 and/or 112 by reviewer 114, for words and/or phrases and/or illustrations that might reveal technical information that must be protected from disclosure to retain its nature as trade secret information under state and federal law). Operation 316 shows reviewing the body of the draft electronic communications text (e.g., reviewing the draft electronic communications text prepared by person 102, where the reviewing is performed on computer 106 and/or 112 by reviewer 114, for possible restricted content in the form of words and/or phrases and/or illustrations in the main information-bearing part of the draft electronic communications text). Operation 318 depicts reviewing an attachment of the draft electronic communications text (e.g., reviewing the draft electronic communications text prepared by person 102, where the reviewing is performed on computer 106 and/or 112 by reviewer 114, for possible restricted content in the form of words and/or phrases and/or illustrations in one or more documents such as Microsoft Word documents and Adobe Acrobat documents). Operation 320 shows reviewing the content of an item linked within the draft electronic communications text (e.g., reviewing the draft electronic communications text prepared by person 102, where the reviewing is performed on computer 106 and/or 112 by reviewer 114, for possible restricted content in the form of words and/or phrases and/or illustrations in one or more websites and/or documents and/or other Internet-based resources that are linked via hyperlink within the draft electronic communications text).

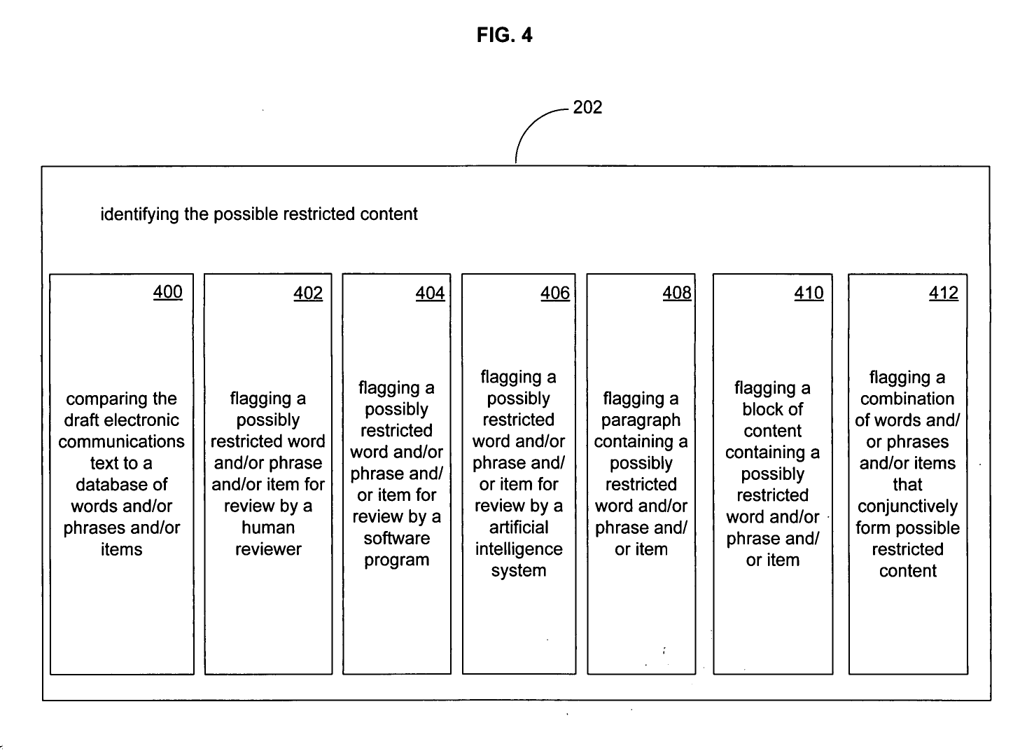

FIG. 4 shows several alternative implementations of the high-level logic flowchart of FIG. 2. Depicted is that operation 202—identifying the possible restricted content—may include one or more of the following operations: 400, 402, 404, 406, 408, 410, and/or 412. Operation 400 depicts comparing the draft electronic communications text to a database of words and/or phrases and/or items (e.g., comparing the draft electronic communications text prepared by person 102 on computer 106 to a database of possible restricted content, where the comparing is performed using computer 106 and/or 112). Operation 402 illustrates flagging a possibly restricted word and/or phrase and/or item for review by a human reviewer (e.g., flagging a word and/or phrase and/or illustration of possible restricted content by colored highlighting for review by the reviewer 114, a human reviewer, using computer 106 and/or 112). Operation 404 illustrates flagging a possibly restricted word and/or phrase and/or item for review by a software program (e.g., flagging a word and/or phrase and/or illustration of possible restricted content by colored highlighting for review by the reviewer 114, a software program, using computer 106 and/or 112). Operation 406 shows flagging a possibly restricted word and/or phrase and/or item for review by an artificial intelligence system (e.g., flagging a word and/or phrase and/or illustration of possible restricted content by colored highlighting for review by the reviewer 114, an artificial intelligence system, using computer 106 and/or 112). Operation 408 depicts flagging a paragraph containing a possibly restricted word and/or phrase and/or item (e.g., flagging a paragraph that includes a word and/or phrase and/or illustration of possible restricted content by colored highlighting for review by the reviewer 114 using computer 106 and/or 112). Operation 410 shows flagging a block of content containing a possibly restricted word and/or phrase and/or item (e.g., flagging a block of content that includes a word and/or phrase and/or illustration of possible restricted content by colored highlighting for review by the reviewer 114 using computer 106 and/or 112). Operation 412 illustrates flagging a combination of words and/or phrases and/or items that conjunctively form possible restricted content (e.g., flagging a number of words and/or phrases and/or illustrations that, taken together, constitute possible restricted content by colored highlighting for review by the reviewer 114 using computer 106 and/or 112).

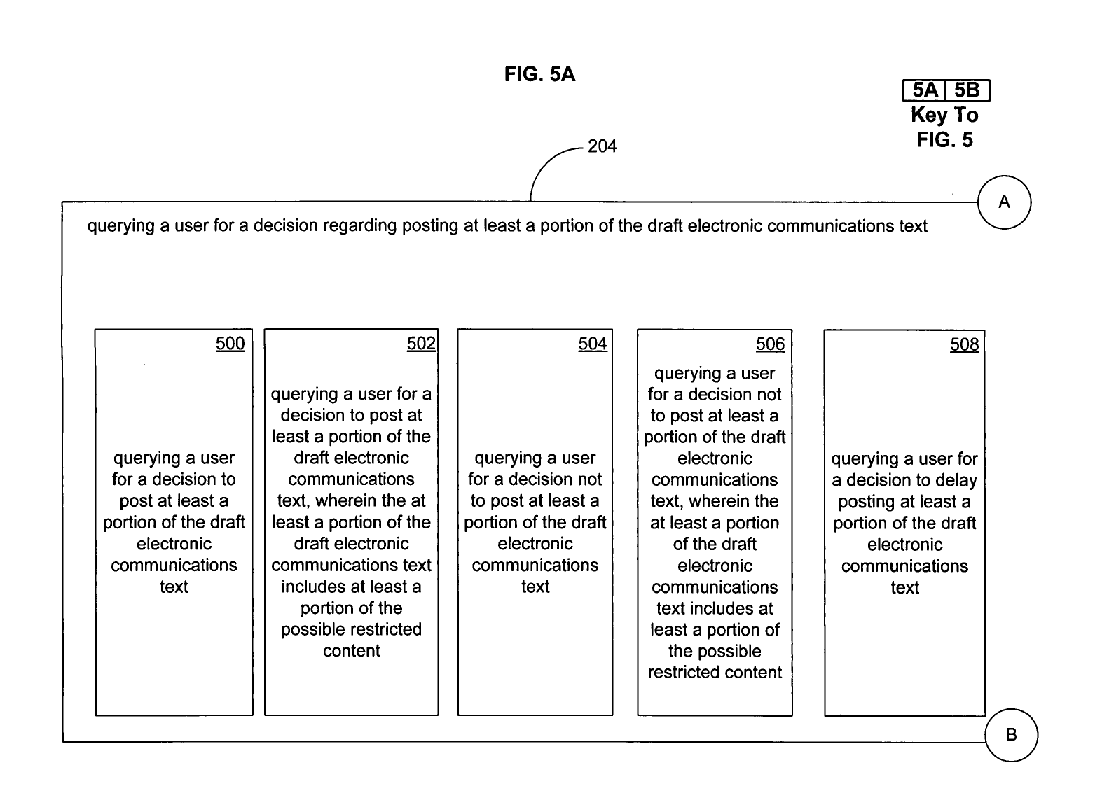

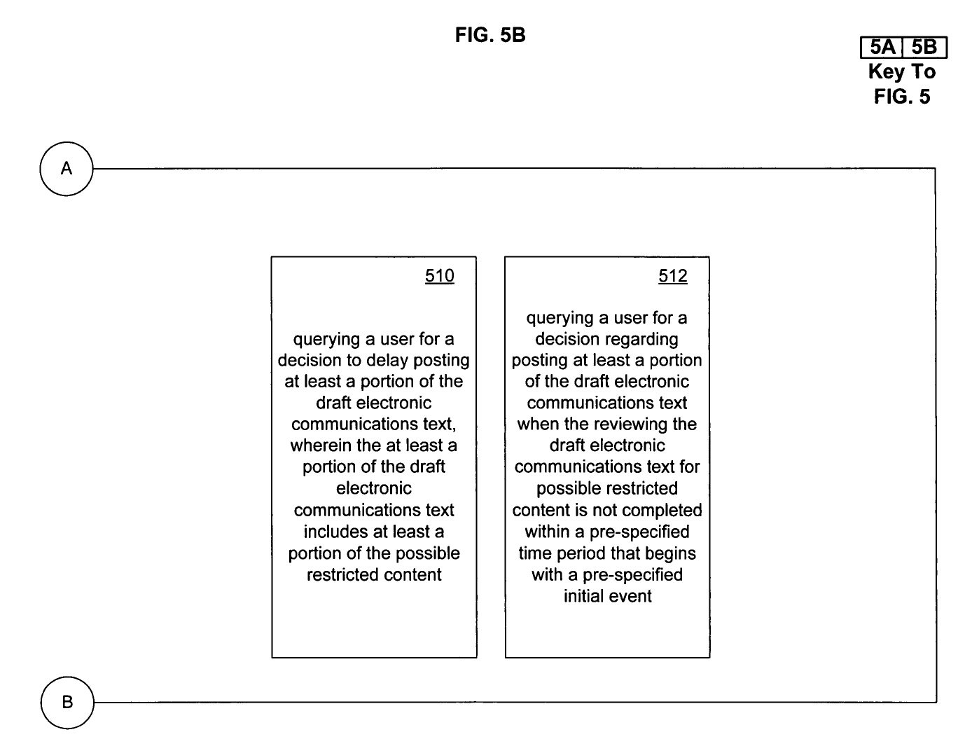

FIG. 5 shows several alternative implementations of the high-level logic flowchart of FIG. 2. Depicted is that operation 204—querying a user for a decision regarding posting at least a portion of the draft electronic communications text—may include one or more of the following operations: 500, 502, 504, 506, 508, 510, and/or 512. Operation 500 illustrates querying a user for a decision to post at least a portion of the draft electronic communications text (e.g., querying a such as person 102 and/or a human reviewer 114 for a decision regarding posting at least a portion of the draft electronic communications text, where the querying is performed using computer 106 and/or 112). Operation 502 depicts querying a user for a decision to post at least a portion of the draft electronic communications text, wherein the at least a portion of the draft electronic communications text includes at least a portion of the possible restricted content (e.g., querying a such as person 102 and/or a human reviewer 114 for a decision to post at least a portion of the draft electronic communications text, where the querying is performed using computer 106 and/or 112, and where the at least a portion of the draft electronic communications text includes at least a portion of the possible restricted content). Operation 504 depicts querying a user for a decision not to post at least a portion of the draft electronic communications text (e.g., querying a such as person 102 and/or a human reviewer 114 for a decision not to post at least a portion of the draft electronic communications text, where the querying is performed using computer 106 and/or 112). Operation 506 shows querying a user for a decision not to post at least a portion of the draft electronic communications text, wherein the at least a portion of the draft electronic communications text includes at least a portion of the possible restricted content (e.g., querying a such as person 102 and/or a human reviewer 114 for a decision not to post at least a portion of the draft electronic communications text, where the querying is performed using computer 106 and/or 112, and where the at least a portion of the draft electronic communications text includes at least a portion of the possible restricted content). Operation 508 illustrates querying a user for a decision to delay posting at least a portion of the draft electronic communications text (e.g., querying a such as person 102 and/or a human reviewer 114 for a decision to delay posting at least a portion of the draft electronic communications text, where the querying is performed using computer 106 and/or 112). Operation 510 shows querying a user for a decision to delay posting at least a portion of the draft electronic communications text, wherein the at least a portion of the draft electronic communications text includes at least a portion of the possible restricted content (e.g., querying a such as person 102 and/or a human reviewer 114 for a decision to delay posting at least a portion of the draft electronic communications text, where the querying is performed using computer 106 and/or 112, and where the at least a portion of the draft electronic communications text includes at least a portion of the possible restricted content). Operation 512 shows querying a user for a decision regarding posting at least a portion of the draft electronic communications text when the reviewing a draft electronic communications text for possible restricted content is not completed within a pre-specified time period that begins with a pre-specified initial event (e.g., querying a such as person 102 and/or a human reviewer 114 for a decision regarding posting at least a portion of the draft electronic communications text, where the querying is performed using computer 106 and/or 112, where the reviewing is not completed within 30 minutes of an initial acceptance of the draft electronic communications text for review).

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use engineering practices to integrate such described devices and/or processes into image processing systems. That is, at least a portion of the devices and/or processes described herein can be integrated into an image processing system via a reasonable amount of experimentation. Those having skill in the art will recognize that a typical image processing system generally includes one or more of a system unit housing, a video display device, a memory such as volatile and non-volatile memory, processors such as microprocessors and digital signal processors, computational entities such as operating systems, drivers, and applications programs, one or more interaction devices, such as a touch pad or screen, control systems including feedback loops and control motors (e.g., feedback for sensing lens position and/or velocity; control motors for moving/distorting lenses to give desired focuses. A typical image processing system may be implemented utilizing any suitable commercially available components, such as those typically found in digital still systems and/or digital motion systems.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

All of the above U.S. patents, U.S. patent application publications, U.S. patent applications, foreign patents, foreign patent applications and non-patent publications referred to in this specification and/or listed in any Application Data Sheet, are incorporated herein by reference, in their entireties.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

We claim:

1. A method related to electronic communications, the method comprising:
reviewing a draft electronic communications text for possible restricted content; and
identifying the possible restricted content.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. A system related to electronic communications, the system comprising:
circuitry for reviewing a draft electronic communications text for possible restricted content; and
circuitry for identifying the possible restricted content.

29. The system of claim 28, further comprising:
circuitry for querying a user for a decision regarding posting at least a portion of the draft electronic communications text.

30. A system related to electronic communications, the system comprising:
means for reviewing a draft electronic communications text for possible restricted content; and
means for identifying the possible restricted content.

31. The system of claim 30, further comprising:
means for querying a user for a decision regarding posting at least a portion of the draft electronic communications text.

32. A program product, comprising:
a signal-bearing medium bearing one or more instructions for reviewing a draft electronic communications text for possible restricted content; and
one or more instructions for identifying the possible restricted content.

33. (canceled)

34. (canceled)

35. The program product of claim 32, wherein the one or more instructions for reviewing a draft electronic communications text for possible restricted content further comprises:
one or more instructions for reviewing the draft electronic communications text for possibly obscene and/or offensive content.

36. The program product of claim 32, wherein the one or more instructions for reviewing a draft electronic communications text for possible restricted content further comprise:
one or more instructions for reviewing the draft electronic communications text for possibly libelous and/or slanderous content.

37. The program product of claim 32, wherein the one or more instructions for reviewing a draft electronic communications text for possible restricted content further comprise:
one or more instructions for reviewing the draft electronic communications text for possible confidential business information content.

38. The program product of claim 32, wherein the one or more instructions for reviewing a draft electronic communications text for possible restricted content further comprise:
one or more instructions for reviewing the draft electronic communications text for possible proprietary information content.

39. The program product of claim 32, wherein the one or more instructions for reviewing a draft electronic communications text for possible restricted content further comprise:
one or more instructions for reviewing the draft electronic communications text for possible embargoed content.

40. The program product of claim 32, wherein the one or more instructions for reviewing a draft electronic communications text for possible restricted content further comprise:
one or more instructions for reviewing the draft electronic communications text for possible privileged content.

41. The program product of claim 32, wherein the one or more instructions for reviewing a draft electronic communications text for possible restricted content further comprise:
one or more instructions for reviewing the draft electronic communications text for possible restricted content concerning competitors.

42. The program product of claim 32, wherein the one or more instructions for reviewing a draft electronic communications text for possible restricted content further comprise:
one or more instructions for reviewing the draft electronic communications text for possible trade secret content.

43. The program product of claim 32, wherein the one or more instructions for reviewing a draft electronic communications text for possible restricted content further comprise:
one or more instructions for reviewing the body of the draft electronic communications text.

44. The program product of claim 32, wherein the one or more instructions for reviewing a draft electronic communications text for possible restricted content further comprise:
one or more instructions for reviewing an attachment of the draft electronic communications text.

45. The program product of claim 32, wherein the one or more instructions for reviewing a draft electronic communications text for possible restricted content further comprise:
one or more instructions for reviewing the content of an item linked within the draft electronic communications text.

46. The program product of claim 32, wherein the one or more instructions for identifying the possible restricted content further comprise:
one or more instructions for comparing the draft electronic communications text to a database of words and/or phrases and/or items.

47. The program product of claim 32, wherein the one or more instructions for identifying the possible restricted content further comprise:
one or more instructions for flagging a possibly restricted word and/or phrase and/or item for review by a human reviewer.

48. The program product of claim 32, wherein the one or more instructions for identifying the possible restricted content further comprise:
one or more instructions for flagging a possibly restricted word and/or phrase and/or item for review by a software program.

49. The program product of claim 32, wherein the one or more instructions for identifying the possible restricted content further comprise:
one or more instructions for flagging a possibly restricted word and/or phrase and/or item for review by an artificial intelligence system.

50. The program product of claim 32, wherein the one or more instructions for identifying the possible restricted content further comprise:
one or more instructions for flagging a paragraph containing a possibly restricted word and/or phrase and/or item.

51. The program product of claim 32, wherein the one or more instructions for identifying the possible restricted content further comprise:
one or more instructions for flagging a block of content containing a possibly restricted word and/or phrase and/or item.

52. The program product of claim 32, wherein the one or more instructions for identifying the possible restricted content further comprise:
one or more instructions for flagging a combination of words and/or phrases and/or items that conjunctively form possible restricted content.

53. The program product of claim 32, wherein the signal-bearing medium further comprises:
at least one of one or more instructions for querying a user for a decision regarding posting at least a portion of the draft electronic communications text.

54. The program product of claim 53, wherein the one or more instructions for querying a user for a decision regarding posting at least a portion of the draft electronic communications text further comprises:
one or more instructions for querying a user for a decision to post at least a portion of the draft electronic communications text.

55. The program product of claim 53, wherein the one or more instructions for querying a user for a decision regarding posting at least a portion of the draft electronic communications text further comprises:
one or more instructions for querying a user for a decision to post at least a portion of the draft electronic communications text, wherein the at least a portion of the draft electronic communications text includes at least a portion of the possible restricted content.

56. The program product of claim 53, wherein the one or more instructions for querying a user for a decision regarding posting at least a portion of the draft electronic communications text further comprises:
one or more instructions for querying a user for a decision not to post at least a portion of the draft electronic communications text.

57. The program product of claim 53, wherein the one or more instructions for querying a user for a decision regarding posting at least a portion of the draft electronic communications text further comprises:
one or more instructions for querying a user for a decision not to post at least a portion of the draft electronic communications text, wherein the at least a portion of the draft electronic communications text includes at least a portion of the possible restricted content.

58. The program product of claim 53, wherein the one or more instructions for querying a user for a decision regarding posting at least a portion of the draft electronic communications text further comprises:
one or more instructions for querying a user for a decision to delay posting at least a portion of the draft electronic communications text.

59. The program product of claim 53, wherein the one or more instructions for querying a user for a decision regarding posting at least a portion of the draft electronic communications text further comprises:
one or more instructions for querying a user for a decision to delay posting at least a portion of the draft electronic communications text, wherein the at least a portion of the draft electronic communications text includes at least a portion of the possible restricted content.

60. The program product of claim 53, wherein the one or more instructions for querying a user for a decision regarding posting at least a portion of the draft electronic communications text further comprises:
one or more instructions for querying a user for a decision regarding posting at least a portion of the draft electronic communications text when the reviewing a draft electronic communications text for possible restricted content is not completed within a pre-specified time period that begins with a pre-specified initial event.
